(19) United States
(12) Patent Application Publication
(10) Pub. No.: US 2019/0118985 A1
(43) Pub. Date: Apr. 25, 2019

(54) GATHERING AND SEALING SYSTEMS FOR ENCASING ARTICLES IN A PROTECTIVE WRAP

(71) Applicant: Vermeer Manufacturing Company, Pella, IA (US)

(72) Inventors: Curt T. Graham, Lynnville, IA (US); Nathan D. Dockter, Pella, IA (US); Kent L. Thompson, Otley, IA (US)

(21) Appl. No.: 15/757,758

(22) PCT Filed: May 16, 2017
(86) PCT No.: PCT/US17/32803

§ 371 Date: Mar. 6, 2018

Related U.S. Application Data
(60) Provisional application No. 62/338,923, filed on May 19, 2016.

(51) Int. Cl. B65B 27/12; A01F 15/07; A01F 25/14; B65B 9/10; B65B 11/10; B65B 51/04; B65B 61/06

(52) U.S. Cl. CPC B65B 27/125; A01F 15/071; A01F 25/14; A01F 2025/142; B65B 11/105; B65B 51/043; B65B 61/06; B65B 9/10

(57) ABSTRACT

Systems for encasing articles such as forage or crop bales in a protective wrap are disclosed. In some embodiments, the system includes a gathering mechanism and sealing device for bunching protective wrap and sealing the ends of the wrap material after one or more articles has been conveyed into the wrap material.

### CROSS-REFERENCE TO RELATED APPLICATION

This application claims the benefit of U.S. Provisional Patent Application No. 62/338,923, filed May 19, 2016, which is incorporated herein by reference in its entirety.

### FIELD OF THE DISCLOSURE

The field of the disclosure relates to systems for encasing articles in a protective wrap and, in particular, systems that include a gathering and sealing system for bunching protective wrap and sealing the ends of the wrap material after the article has been conveyed into the wrap material.

### BACKGROUND

Crop forages such as hay (e.g., alfalfa and/or grass hay) are periodically cut in the field, dried and compacted into bales for transport and storage of the forage material. In some cases and, in particular when silage material is baled, it may be desirable to wrap the bales in protective material such as plastic. Wrapping the silage promotes the ensiling process in which the material ferments, thereby improving the digestibility of the material for ruminants. Silage may be composed of various materials such as field crops or various grasses or legumes (i.e., alfalfa). In the case of forage bales, wrapping the bales allows the bales to be protected from rain and precipitation, which may degrade the nutrient value of the material.

It may be desirable to wrap a module of bales (e.g., one, two, three, four or even more bales wrapped together as a sealed unit). Such modules allow a small number of bales to be stored and later opened for livestock feeding without exposing a large number of bales to the ambient.

A need exists for an apparatus for wrapping bales in which the apparatus is able to gather and bunch the wrapping material and/or for sealing the ends of the wrapping material around the module.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a bale wrapping system for wrapping bales in a protective wrap. The system includes a wrapping device for stretching a tube of wrapping material as a module of bales passes through the wrapping device and into the protective wrap. The system also includes a gathering mechanism for bunching wrapping material to seal the material after wrapping the module of bales. The gathering mechanism includes a set of arms that pivotally rotate to reduce the size of an opening to bunch the material within the opening and to a sealing position.

Another aspect of the present disclosure is directed to a gathering and sealing system for wrapping articles in a protective wrap. The system includes a gathering mechanism for bunching wrapping material to seal the material after wrapping the articles. The gathering mechanism includes a set of arms that pivotally rotate to reduce the size of an opening to bunch the material within the opening and to a sealing position. The system includes a sealing device that actuates to seal the wrapping material when the gathering mechanism is in the sealing position. The sealing device is disposed within an arm of the gathering mechanism.

Yet another aspect of the present disclosure is directed to a gathering mechanism for bunching wrapping material to seal the material after wrapping an article. The gathering mechanism has a vertical axis. The gathering mechanism includes at least two portions that move to adjust the size of an opening formed between the portions from a wrapping position through which wrapped articles pass to a sealing position in which the wrapping material is bunched to seal the wrapping material. The gathering mechanism, in the wrapping position, has a widest width W₁ that extends between a first end and a second end of the gathering mechanism and that is perpendicular to the vertical axis. The opening in the wrapping positon has a width W₂ that is perpendicular to the vertical axis. The ratio of W₁ to W₂ is less than about 3:2.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective top view of a system for encasing articles that is arranged for encasing large round bales in a protective wrap;

FIG. 2 is a perspective view of the system, with two bales loaded thereon for wrapping;

FIG. 3 is a perspective view of the system with the two bales being wrapped;

FIG. 4 is a perspective view of the system with wrapping material being bunched in a gathering mechanism of the system;

FIG. 5 is a perspective view of the packing conveyor and wrapping device of the system in an extended position, with a tube of wrap attached to the wrapping device;

FIG. 6 is a perspective view of the packing conveyor and wrapping device in a retracted position, with a tube of wrap attached to the wrapping device;

FIG. 7 is a perspective view of the gathering mechanism in the wrapping position;

FIG. 8 is a rear view of the gathering mechanism in the wrapping position;

FIG. 9 is a rear view of the gathering mechanism in the wrapping position showing the gathering mechanism width and the width of the opening formed by the gathering mechanism;

FIG. 10 is a rear view of the gathering mechanism in the sealing position;

FIG. 11 is a perspective view of a sealing device for sealing gathered wrap material;

FIG. 12 is a perspective view of a cutter and the plungers of the sealing device;

FIG. 13 is a perspective view of the die of the sealing device; and

FIG. 14 is a rear view of the sealing device in the sealing position.

Corresponding reference characters indicate corresponding parts throughout the drawings.

### DETAILED DESCRIPTION

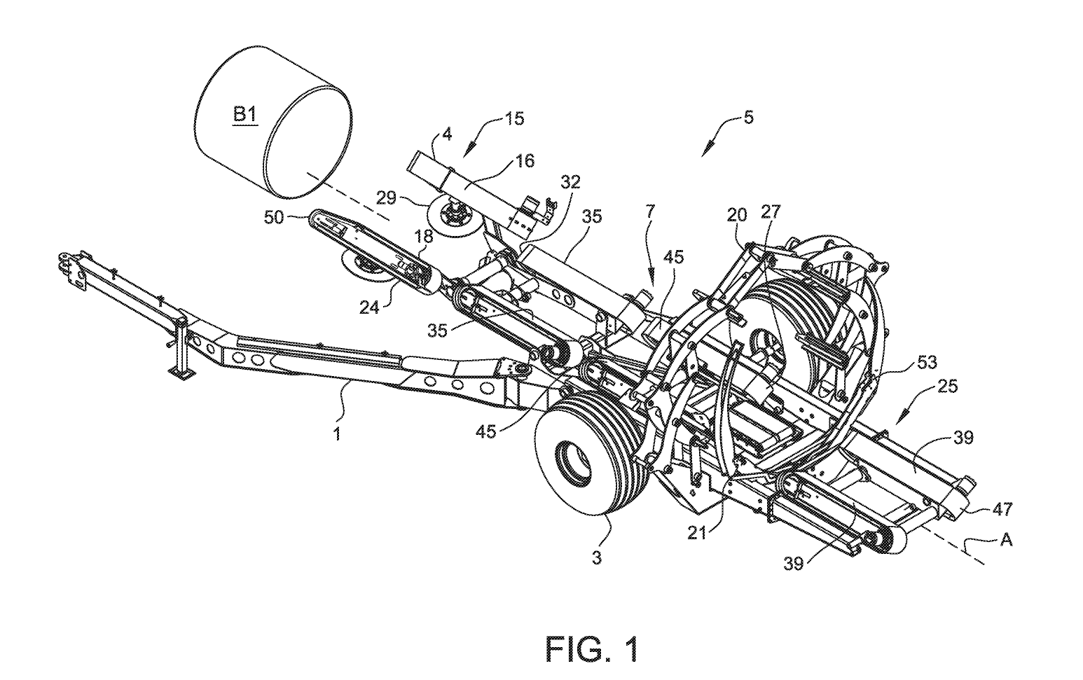

A system for encasing articles in a protective wrap is generally referred to as “5” in FIG. 1. While the system 5 is shown and may be described herein as a bale wrapping apparatus, the system should not be limited to a bale wrapping apparatus or other agriculture implement. The system 5 generally may be any device or apparatus having a gathering mechanism and or sealing device for sealing the ends of protective wrap unless stated otherwise. For example, the system 5 may, in one variation, be non-mobile, and various articles may be loaded onto the system (as opposed to being picked up by the system itself) and processed to wrap the articles in a protective wrap. Suitable articles which may be wrapped include any articles wrapped for purposes of shipping and/or storage. In embodiments in which the system is a mobile bale wrapping apparatus, the articles may be small square bales, large square bales, or round bales of forage or crop material.

The system 5 (which may also be referred to herein in some variations as a “bale gathering apparatus”) includes a bed assembly 7 for supporting and conveying bales and a loading assembly 15 for lifting a bale from a bale-supporting surface (e.g., the ground) and conveying it to the bed assembly 7. The apparatus 5 also includes a discharge assembly 25 for conveying one or more bales (e.g., a “module” of bales) from a bale wrapping device 20 and for unloading the bales on a surface.

The apparatus 5 includes a tongue 1 for pulling the apparatus by use of, for example, a tractor or other pulling vehicle. In some embodiments (not shown) the apparatus 5 includes its own propulsion mechanism rather than being pulled by a pulling vehicle. The apparatus 5 includes ground-engaging wheels 3. Tracks (not shown) may be used as an alternative to the wheels 3.

The loading assembly 15 (and/or a portion of the bed assembly 7) may be pivotally attached to a chassis 21. An actuator (not shown) may be extended or retracted to allow the loading assembly 15 to be tilted between various positions such as a loading position in which skids 29 contact the ground and a travel positon in which the loading assembly 15 is raised.

The discharge assembly 25 (and a rear portion of the bed assembly 7) may be pivotally attached to the chassis 21. Actuators (not shown) may be used to raise and lower the discharge assembly 25 (e.g., for unloading of a module of bales onto the unloading surface).

The loading assembly 15 includes two arms 4, 24 that together are the leading portion of the apparatus 5 to contact a bale during loading. Each arm 4, 24 includes an endless conveyor 16, 18 looped around various drive, idler and/or support rollers for rotating the conveyor. In some cases the drive roller is positioned at the front, in some cases at the rear, and, in some embodiments, at both the front and rear. The movement of the belts 16, 18, around the front roller and backward along the upper portion of the belt path, is effective to lift a bale off the ground and simultaneously cause the bale to move toward the bed assembly 7. This lifting and transporting action occurs after the two conveyor belts contact a bale B1.

The arms 4, 24 are pivotally attached to a bed frame that supports the conveyors of the bed assembly 7. In some embodiments, the arms 4, 24 pivot together and, in other embodiments, they may pivot separately. The arms 4, 24 may be attached by use of a pivot pin (not shown) or by any other suitable method which allows the arms 4, 24 to pivot relative to the bed assembly 7.

It should be noted that the loading assembly 15 of the illustrated embodiment is exemplary and the apparatus 5 may include alternative or additional components that suitably lift bales from a surface and onto the apparatus 5.

The apparatus 5 has a loading end 50, discharge end 47 and a central lengthwise axis A that extends through the loading end and discharge end. In the illustrated embodiment, the first arm 4 and second arm 24 are substantially parallel to the lengthwise axis A.

The bed assembly 7 has a set of bed conveyors 35 add a set of infeed conveyors 45. The bed conveyors 35 are disposed between the loading arms 4, 24 and the infeed conveyors 45. The first and second bed conveyors 35 and first and second infeed conveyors 45 each form a cradle with bales being secured within the cradle as they are conveyed. The bed assembly 7 extends from a first end 32 to a second end 27. Each of the bed conveyors 35 and infeed conveyors 45 include an endless belt that may be routed around an idler roller and a powered roller (front or back) that may be rotated to cause the belt to move which results in moving bales away from the loading assembly 15 and toward the second end 27 of the bed assembly 7. Other conveyors arrangements, such a chain drive system, may be used.

In some embodiments, rather than having two conveyors that form a cradle, each section includes a single conveyor that forms a floor upon which the bales rest for moving bales toward the second end 27.

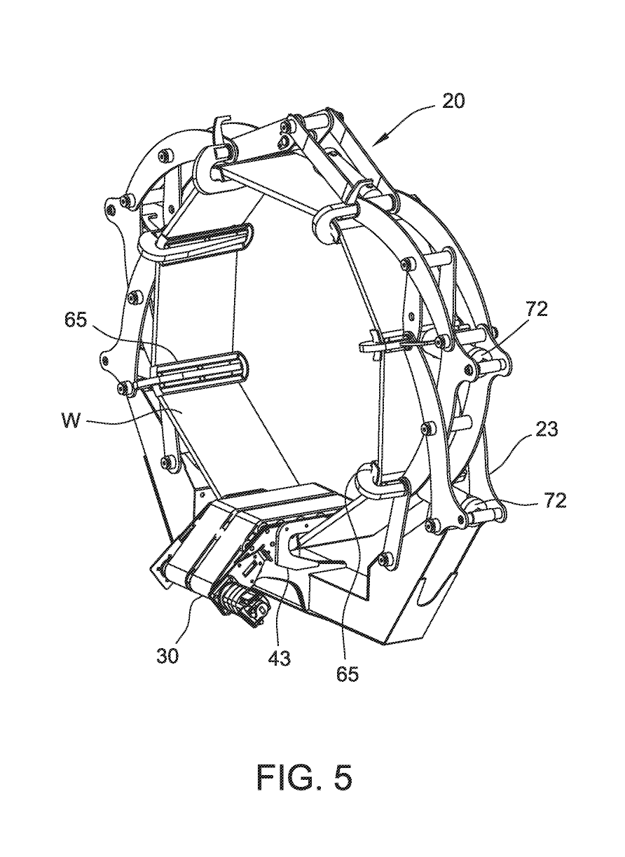

A bale wrapping device 20 is mounted to the chassis (or to a rear frame that is pivotal with respect to the chassis). The bale wrapping device 20 is disposed between the rear portion of the bed assembly 7 and the discharge assembly 25. Referring now to FIG. 5, the wrapping device 20 includes an articulating frame 23. The articulating frame 23 includes a number of attachment members 65. A tube W of protective wrap material is fitted on the attachment members 65 such that the attachment members 65 are within the inner space formed by the material. The wrapping device 20 may have alternative configurations such as two separate arms that extend upward to which the attachment members 65 are attached, as shown and described in WO 2014/200337, which is incorporated herein by reference for all relevant and consistent purposes. Any suitable wrapping material may be used, such as commercially available LASTIC TUBE wrapping from AT Films (Edmonton, Canada).

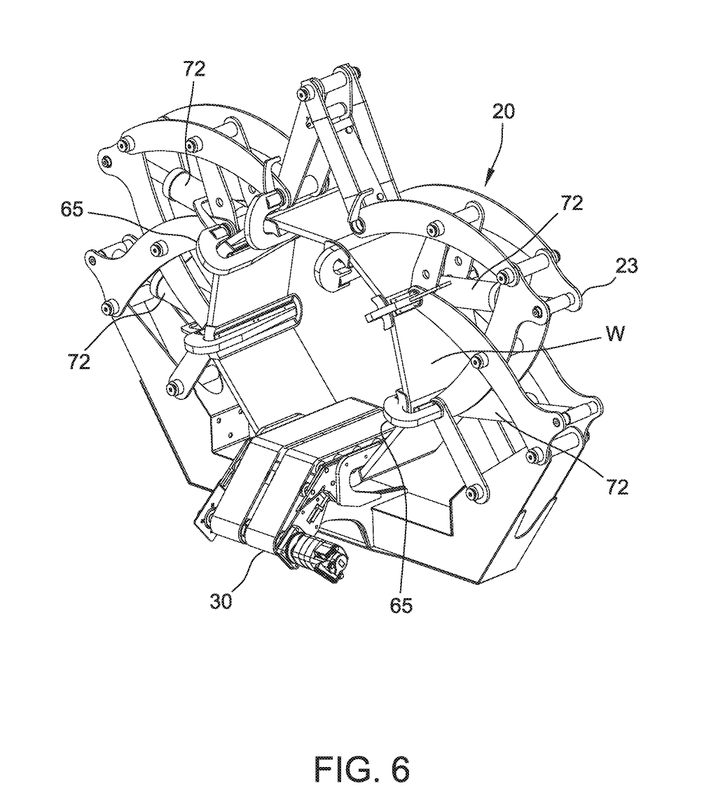

Actuators 72 (which may be hydraulic or pneumatic cylinders) may be extended to adjust the articulating frame 23 of the wrapping device 20 into a retracted position (FIG. 6) in which the tube of wrap material W may be slid onto attachment members 65. After placement of the wrapping material W, the actuators 72 may be retracted to adjust the articulating frame 23 into an extended position (FIG. 5) in which bales may pass through the device 20 and wrap W.

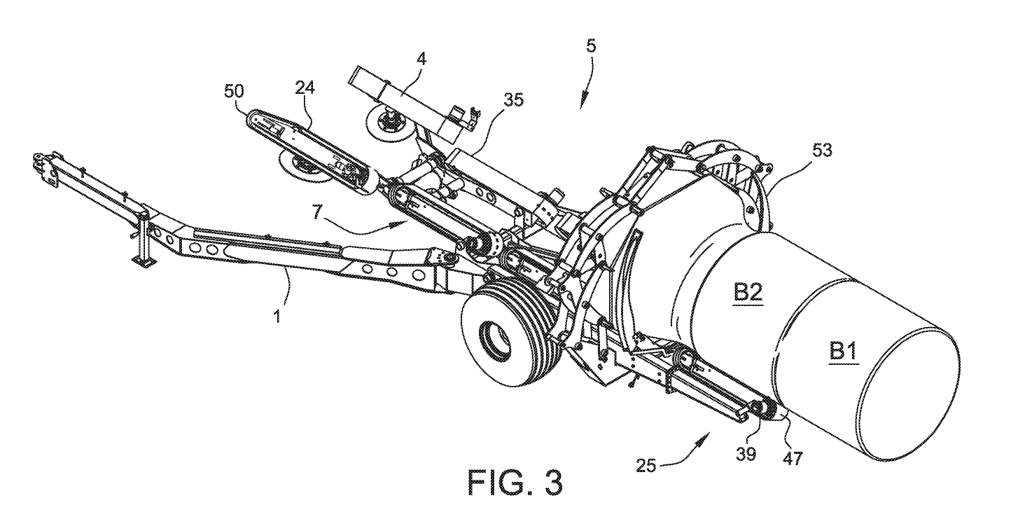

During wrapping, the wrapping device 20 is maintained with an inner radius greater than the radius of the bales to allow bales to pass through the wrapping device. The bales are conveyed toward the discharge end 47 of the apparatus 5 causing the first bale B1 to contact a sealed end of the wrapping material. As bales continue to be conveyed through the wrapping device 20, further wrapping material is released (FIG. 3) As the wrapping material is released, the wrapping material shrinks to the radius of the bales.

A packing conveyor 30 (FIG. 5) extends through the wrapping device 20 to convey articles into the tube of wrapping material W. Any conveyance mechanism (e.g., single belt, chain drive, powered or unpowered rollers, or cylinder that moves the bales forward, etc.) that facilitates movement of the wrapped bales toward the discharge end 47 of the apparatus 5 may be used unless stated otherwise.

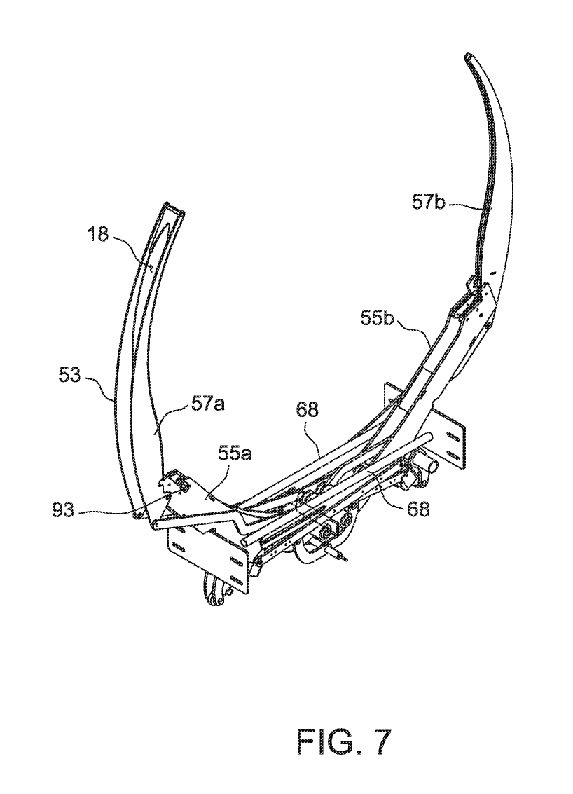

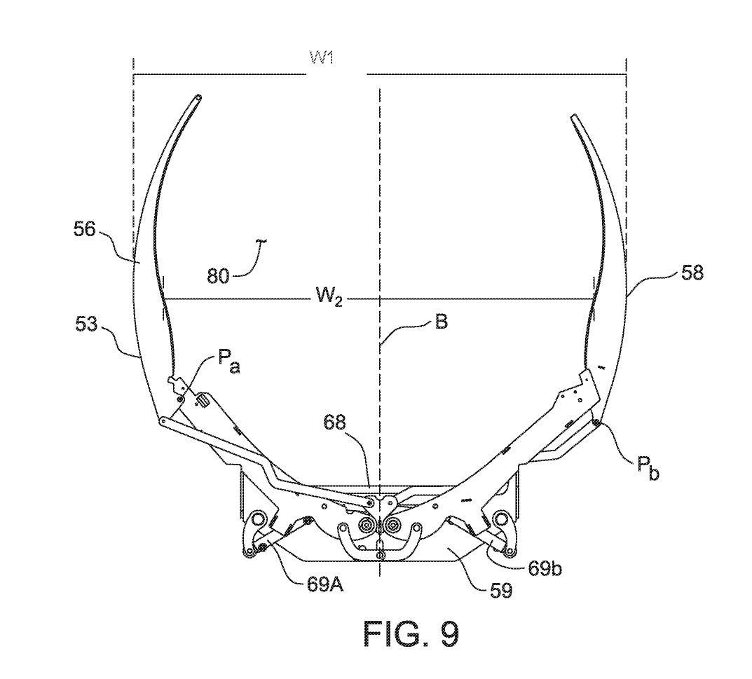

The wrapping device 20 may be part of a bale wrapping system. The system may also include a gathering mechanism 53 (FIG. 1) for bunching wrapping material to seal the material after wrapping a module of bales. The gathering mechanism 53 includes a set of lower arms 55a, 55b (FIG. 7) and a set of upper arms 57a, 57b. Each lower arm 55 is pivotally connected to a corresponding upper arm 57 at pivot points Pₐ, P_{b} (FIG. 9), respectively.

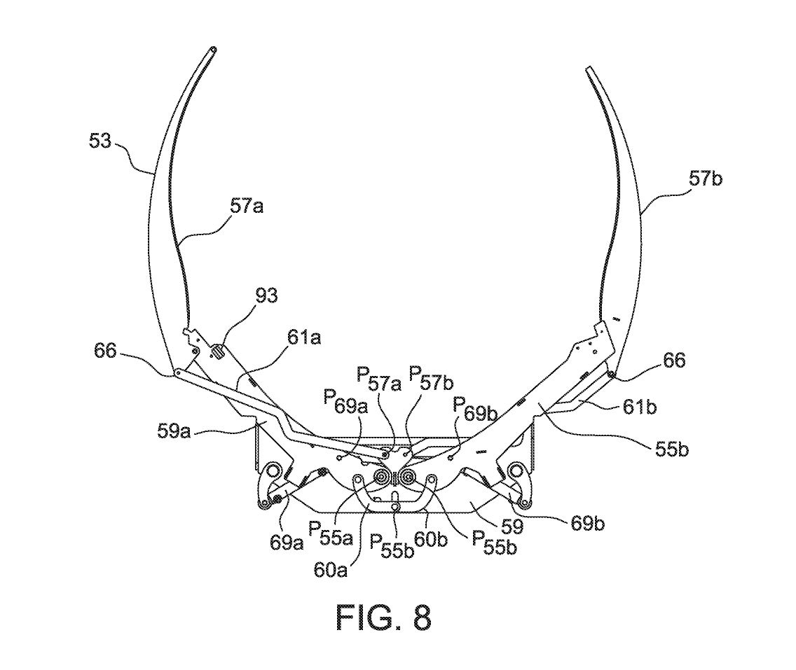

The two lower arms 55a, 55b are pivotally attached to a base 59 at pivot point P₅₅ₐ, P_{55b} (FIG. 8), respectively. The two lower arms 55a, 55b are also pivotally attached to lower arm linkages 60a, 60b which are in turn attached to the base 59 at a common pivot point P₆₀. The first upper arm 57a is attached to an upper arm linkage 61a at the distal end 66 of the upper arm 57a. The second upper arm 57b is attached to two upper arm linkages 61b (one shown) at its distal end 66. The linkages 61a, 61b are attached to the base 59 at pivot points P₅₇ₐ, P_{57b}.

As shown in FIG. 7, the first upper arm 57a has a width that is greater than the width of the second upper arm 57b. The first upper arm 57a also includes a slot 78 formed therein. In this manner, the second upper arm 57b may rotate into the slot 78 of the first arm 57a as the arms are rotated to bunch the wrapping material.

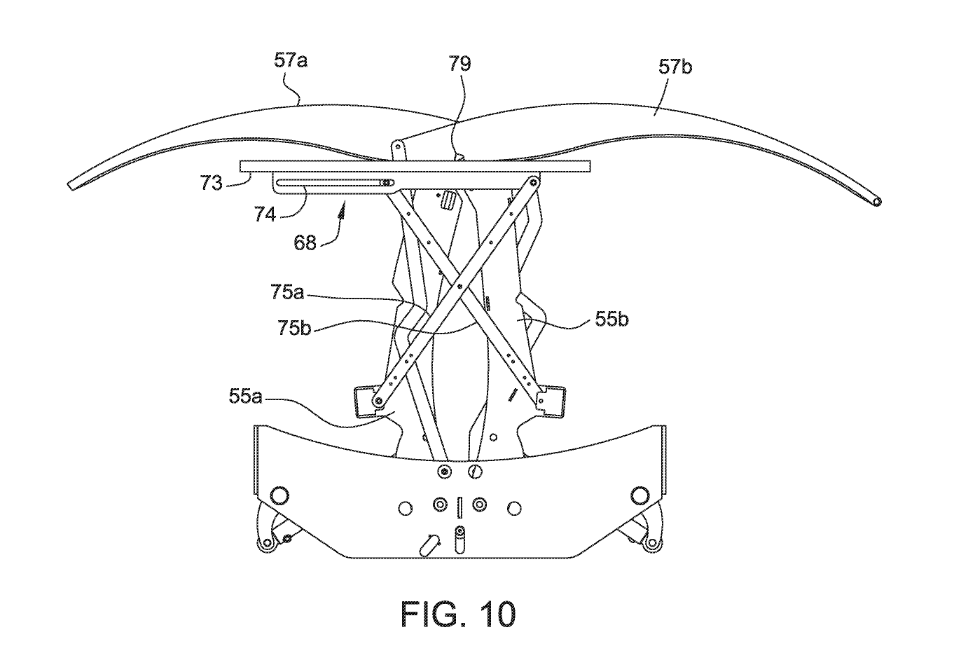

The gathering mechanism 53 also includes a pair of scissor links 68 with the two scissor links being across from each other relative to the lengthwise axis A (FIG. 1) of the apparatus. In other embodiments, the gathering mechanism includes a single scissor link. Each scissor link 68 includes a blade portion 73 (FIG. 10) having a slot 74 formed therein. The scissor link 68 includes first and second scissor linkages 75a, 75b. The first scissor linkage 75a is pivotally attached to the blade 73. The second linkage 75b is also attached to the blade 73 with the attachment point being movable within the slot 74. The first scissor linkage 75a is pivotally attached to the first lower arm 55a and the second scissor linkage 75b is pivotally attached to the second lower arm 55b.

The gathering mechanism 53 includes two actuators 69a, 69b (FIG. 8) that are connected to the lower arms 55a, 55a at pivot points P₆₉ₐ, P_{69b}. The actuator 69a, 69b may be hydraulic or pneumatic cylinders. Each actuator pivot point P₆₉ₐ, P_{69b} lies between a pivot point between the lower arm 55 and the base 59 (P₅₅ₐ, P_{55b}) and a pivot point between the lower arm 55 and an upper arm 57 (Pₐ, P_{b} shown in FIG. 9).

After a module of bales has passed through the gathering device 53 and wrap material extends through the device (FIG. 3), each actuator 69a, 69b (FIG. 8) may be extended to cause the lower arms 55a, 55b and upper arms 57a, 57a to rotate and for the scissor link 68 to rise to cause the wrapping material to be bunched in an opening 79 (FIG. 10). In this manner the lower arms 55, upper arms 57 and scissor link 68 move from an initial wrapping position (FIG. 8) in which wrapped bales may move through the opening of the gathering mechanism to a sealing position (FIG. 10) in which the wrap material is bunched and ready for sealing. The sidewalls of the opening 79 in the sealing position are portions of the first and second upper arms 57a, 57b and the scissor links 68.

The two upper arms 57a, 57b may have a different arc of rotation than the lower arms 55a, 55b which cause the upper arms to pivot more than the lower arms into the sealing position (e.g., lower arms pivot upward about 45° while the upper arms pivot about 90° and become transverse to the lower arms).

In some embodiments, the gathering mechanism 53 may be arranged to have a small width relative to the articles that are being wrapped (e.g., bales). Generally, the gathering mechanism 53 has two portions that move (e.g., a first set of lower and upper arms 55a, 57a and a second set of lower and upper arms 55b, 57b) from a wrapping position (FIG. 8) through which wrapped articles pass to a sealing position (FIG. 10) in which the wrapping material is bunched to seal the wrapping material. The two portions are each arcuate and form a ring in the wrapping position.

The gathering mechanism 53 in the wrapping position has a largest or outermost width W₁ (FIG. 9) that extends between a first end 56 and a second end 58 and that is transverse to the vertical axis B of the gathering mechanism 53. The opening 80 of the gathering mechanism 53 in the wrapping position at the same vertical height at which W₁ was determined (i.e., the largest width of the gathering mechanism) has a width W₂. The ratio of W₁ to W₂ is less than about 3:2, less than about 5:4 or even less than about 6:5. In some embodiments, W₂ is at least about 0.5 meters.

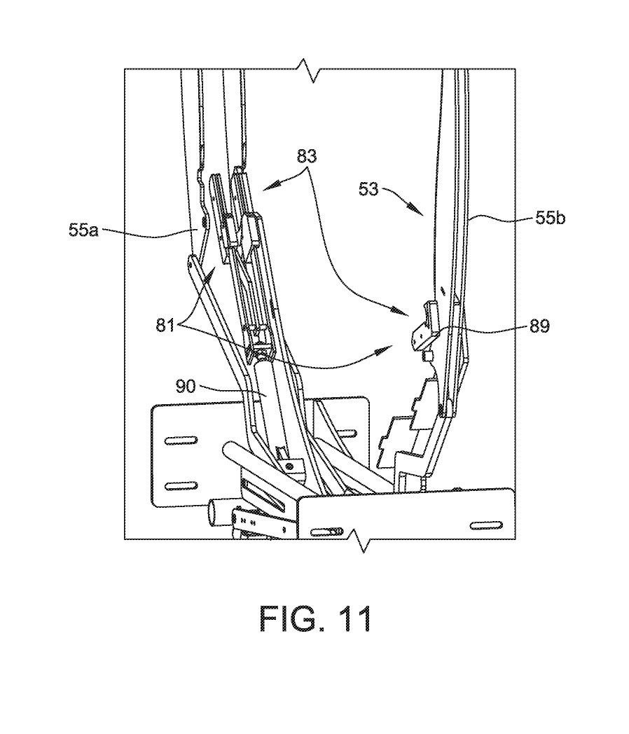

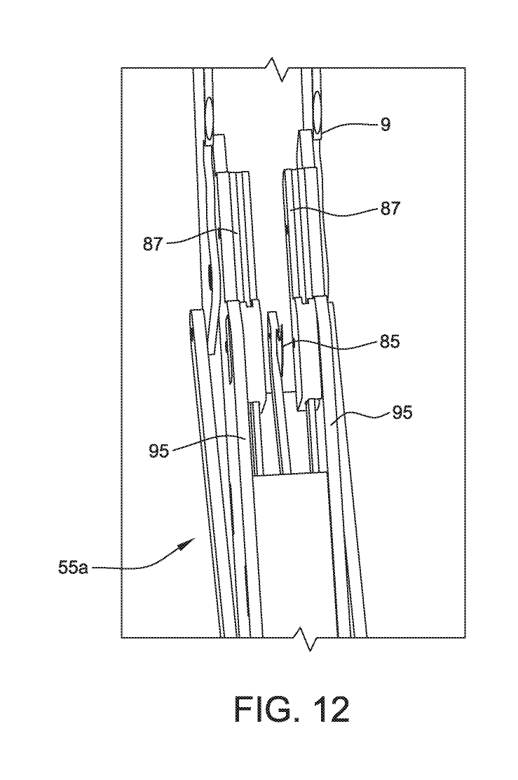

In some embodiments, the gathering mechanism 53 is part of a gathering and sealing system. Such systems may include a sealing device 81 (FIG. 11) that actuates to seal the wrapping material when the gathering mechanism 53 is in the sealing position. As shown in FIG. 11, a portion of the sealing device 81 is within the first arm 55a. A second portion of the sealing device 81 is within the second lower arm 55b. In some embodiments and shown in FIG. 11, the system includes a second sealing device 83. The system may also include a cutter 85 (FIG. 12) for severing the wrapping material. The cutter 85 may be between the first and second sealing devices 81, 83. In this manner, the system may seal the free end of a wrapped module of bales and may seal the other end of the wrapping material, and concurrently or thereafter sever the material, which allows another module of bales to be placed into the wrapping material for wrapping.

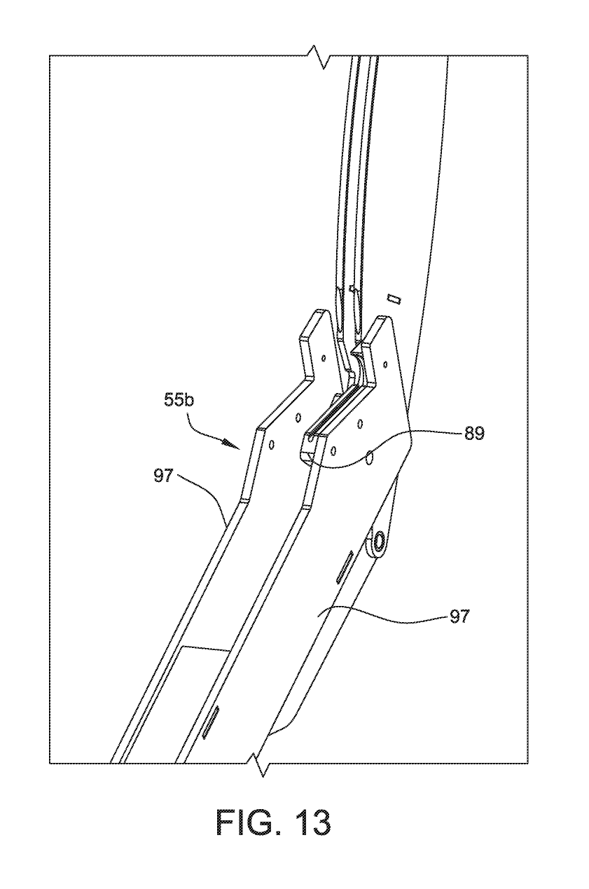

In the illustrated embodiment, the sealing devices 81, 83 are clipping devices. Each clipping device 81, 83 includes a plunger 87 (FIG. 12) that is attached to and is within the first lower arm 55a and a die 89 (FIG. 13) that is disposed within and attached to the second lower arm 55b. The plungers 87 are within two plates 95 (FIG. 12) of the first lower arm 55a. Clips (not shown) are supplied to each plunger 87 through openings 93 (FIG. 8) formed in both sides of the first lower arm 55a. The die 89 is within two plates 97 (FIG. 13) of the second lower arm 55b.

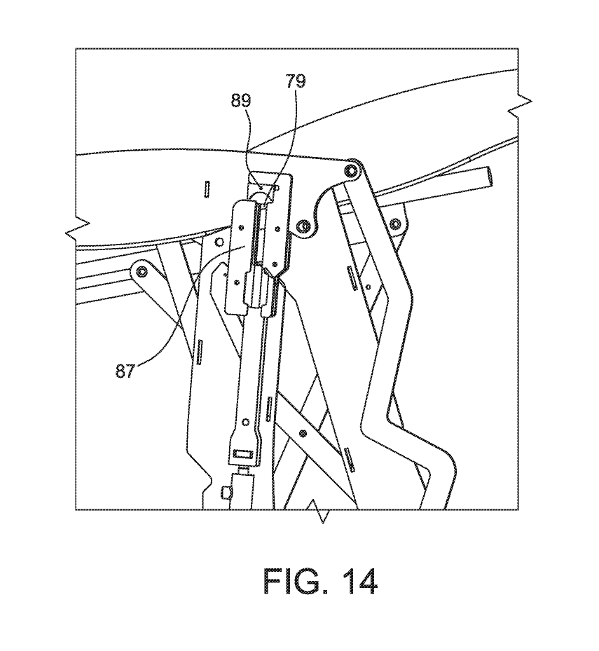

After the wrapping material is bunched and the plungers 87 are aligned with the die 89 (FIG. 14), the plungers 87 are activated by a cylinder 90 (FIG. 11). Each clip held with each plunger 87 contacts the wrap at two different positions relative to the lengthwise axis A of the apparatus 5. The clip continues upward and contacts the die 89 which forces the clip to bend and to pinch the wrap material shut.

In this regard, the term “seal” or “sealing” as used herein in reference to the sealing device 81, 83 and the resulting module of wrapped articles should not be considered to require a perfect hermetic seal. Relatively small amounts of air may be transferred in and out of the clipped ends with the amount of air being transferred being sufficiently low to allow the crop or forage material to ensile.

The sealing devices 81, 83 are exemplary and other types of sealing devices may be used in combination with the gathering mechanism unless stated otherwise.

Once sealed, the cutter 85 (FIG. 12) may be actuated to sever the material. The cutter 85 may be attached to the same actuator as the sealing devices 81, 83. By positioning the cutter 85 lower than the sealing devices 81, 83, the sealing device may first seal (e.g., clip) the wrapping material in two positions. The cutter 85 than continues upward and severs the material between the two sealing devices 81, 83.

The discharge assembly 25 (FIG. 1) conveys bales, which have been encased in the wrapping material W, from the packing conveyor 30 toward the discharge end 47 of the apparatus 5. In the illustrated embodiment, the discharge assembly 25 includes a set of discharge conveyors 39. The discharge conveyors 39 form a cradle within which the bale is secured during transport. Similar to the bed conveyors 35 and infeed conveyors 45 of the bed assembly 7, each discharge conveyor 39 of the discharge assembly 25 includes an endless belt routed around a front idler roller and a rear powered roller. The conveyors 39 may be rotated to cause the wrapped bales to move toward the discharge end 47 of the apparatus 5 for bale unloading.

Any conveyance mechanism (e.g., single belt, chain drive, powered or unpowered rollers, etc.) that facilitates movement of the wrapped bales toward the discharge end 47 of the apparatus 5 may be used to discharge bales unless stated otherwise. In some embodiments, the discharge assembly 25 is eliminated and the bales are discharged to the ground from packing conveyor 30.

The various conveyor belts of the system 5 may be driven by hydraulics, by a power-take-off system, or by an electrical drive. The drive system for driving the belts may be on-board (i.e., carried by the apparatus 5) or off-board (e.g., provided by a tow vehicle). Any suitable type of conveyer belts or conveyor systems may be included in the system 5 at any of the various locations where a conveyance mechanism is provided. For instance, a conveyor belt composed of nylon or fiberglass fibers covered by materials such as rubber, PVC, thermoplastic polymer or the equivalent may be used. Chain conveyor systems may also be used without departing from the scope of the present disclosure. In this regard, “conveyor belt” as used herein includes any arrangement in which a belt, chain, track or the like is moved around a series of pulleys, gears and/or drive wheels to cause movement of the belt, chain or track.

In some embodiments, each of the set of bed conveyors 35, set of infeed conveyors 45 and set of discharge conveyors 39 are independently controlled to allow bales to be indexed to form a module of two or more bales. In some embodiments, the infeed conveyors 35 and packing conveyor 30 are part of the same control circuit (e.g., operated in series in the same hydraulic circuit) and are controlled together (i.e., are operated to start and stop together and operate at the same speed).

The position of the loading apparatus 5 relative to the pull vehicle (i.e., whether the apparatus is pulled directly behind the pull vehicle or at an offset position, such as when bales are being gathered from the field) may be adjusted by manipulating the angle between the tongue 1 and the axis A of the apparatus by use of hydraulics or by any other method suitable to those of skill in the art. In other embodiments, the tongue 1 is eliminated, and the apparatus 5 may be self-propelled and/or driven autonomously through the field on which the bales rest.

In operation, the system 5 is pulled by the pull vehicle (not shown) toward a bale with the loading assembly in a downward loading position as shown in FIG. 1. The vehicle may provide the power for running the various conveyors and positioning systems (e.g., by use of hydraulics) or the apparatus 5 may include its own dedicated, (e.g., on-board) power system (e.g., hydraulic system). The apparatus described herein 5 uses a hydraulic system, but other power transfer technologies, such as an electrical system may be used.

The system 5 (e.g., loading and discharge conveyors, packing conveyor and wrapping device) may be sized to wrap a particular size of article. Generally, the system 5 handles bulk items such as articles having a smallest dimension (e.g., height, width, depth, length, and/or radius) of at least 0.5 meters or even at least 1 meter. The system 5 may be sized to wrap bales of forage material such as small square bales, large square bales, and/or cylindrical bales commonly referred to as “round” bales of forage or crop material.

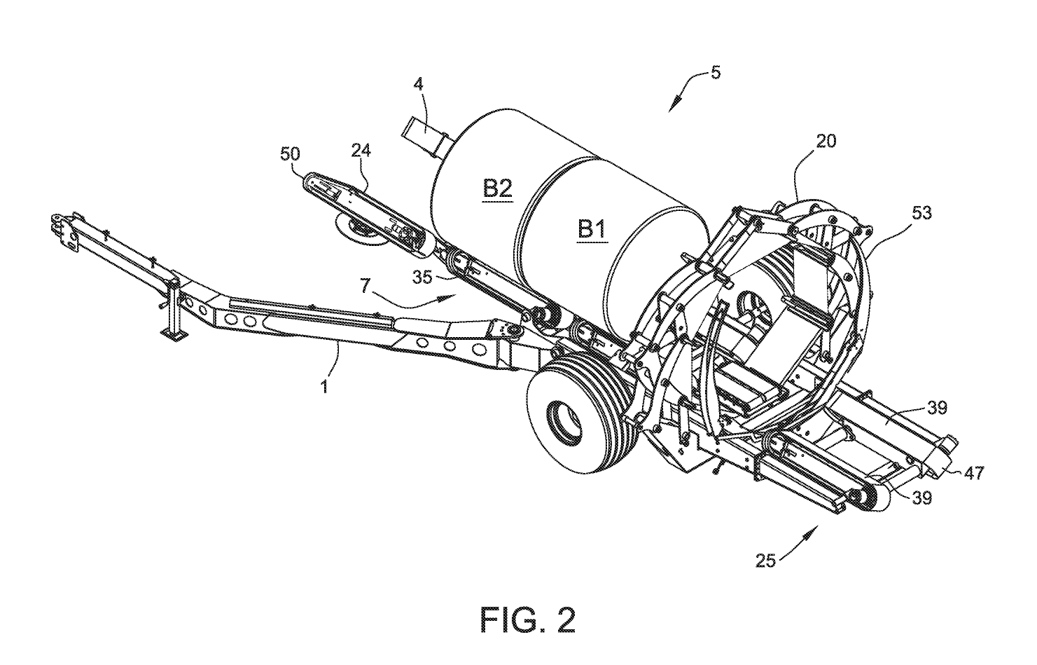

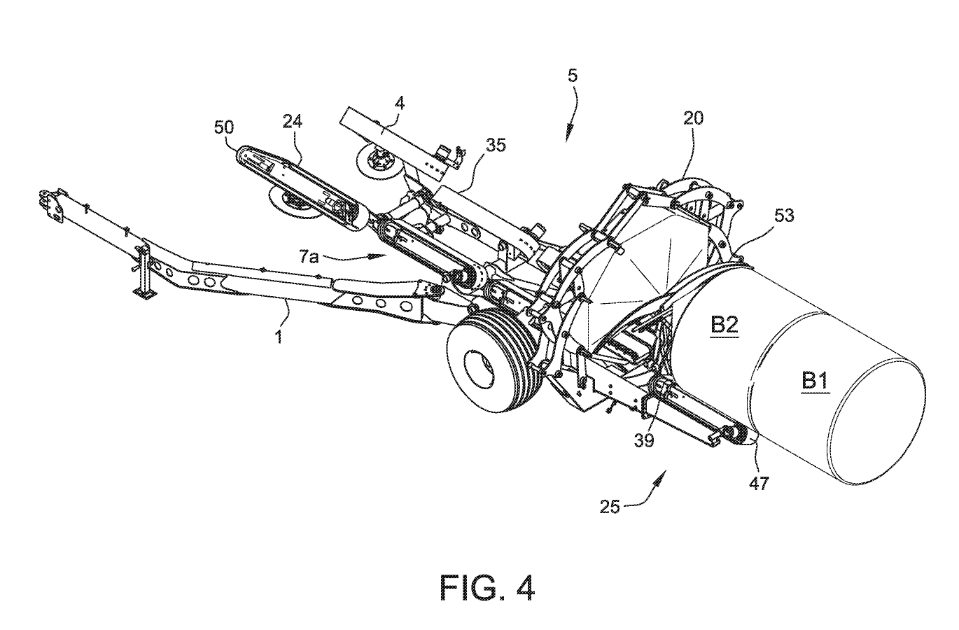

The system illustrated in FIGS. 1-14 is suitable for picking up round bales. Round bales are used for harvesting any material capable of being formed into a cylindrical bale such as silage or traditional hay crops (e.g., alfalfa or grass), corn stover or other crop residues, cotton, or woody products like small diameter trees. The round bales may have a variety of sizes, typically ranging from 1 meter to 2.5 meters in length (about 40 to 100 inches). While the apparatus 5 is shown in FIGS. 1-14 as loading round bales, the apparatus may be adapted to pick up large square bales, small square bales, or other articles without limitation.

The speed of the packing conveyor 30 may be controlled to match the speed of the infeed conveyors 45 of the bed assembly 7. In some embodiments, the speed of the packing conveyor 30 is controlled to match the speed of the conveyors 39 of the discharge assembly 25. In other embodiments, the packing conveyor 30 is independently controlled from the discharge conveyors 39 and/or the bed conveyors 35 and/or the conveyors of the first and second arms 4, 24. Independent control of the various conveyors allows for indexing of bales to form various sizes of bale modules. In some embodiments, the system is controlled such that the bed conveyors 35, infeed conveyors 45, packing conveyor 30 and/or discharge conveyors 39 match the ground speed of the apparatus 5.

As shown in FIG. 1, the bale B1 and apparatus 5 should be oriented such that the ends 40 of the cylindrical bale are perpendicular to the apparatus 5 as the apparatus 5 approaches the bale B1. The chassis 21 and tongue 1 are caused to be at an angle relative to one another such that the loading assembly 15, bed assembly 7 and discharge assembly 25 travel outside of the path of the pull vehicle (not shown) to allow the pull vehicle to travel to the outside of a path established by the bales targeted for loading.

Bales are processed by transferring a bale from the surface on which it rests and onto the loading assembly 15 and onto the bed assembly 7. The bed assembly 7 moves the bale toward packing conveyor 30 which, in turn, propels the bale through the wrapping device 20 and gathering device 53. The bale contacts a sealed end of a tube of protective wrap W and begins to unfurl protective wrap from the tube causing the protective wrap to contract and surround the bale. The bale continues to moves through the wrapping device 20 and begins to contact the discharge assembly 25. After the module of bales pass through the gathering device 53, the gathering device is actuated to rotate the device into its sealing position (FIG. 10). The plungers 87 (FIG. 12) of the sealing devices 81, 83 (FIG. 11) are actuated with the cutter 85 (FIG. 12) to cause the wrap material to be sealed at two positions and severed between the clips. After a bales is wrapped, sealed and cut (and typically a module of bales is wrapped, sealed and cut), the bale and/or the bale module, is unloaded from the discharge assembly 25.

Bales may be processed in the system 5 and wrapped in any suitable manner and order. For example, a single bale may be loaded onto the loading assembly 15 and transferred to the bed assembly 7. The apparatus 5 may then be moved to a second bale which is loaded onto the apparatus and caused to contact the first bale to form a module of bales. The module of bales may then be moved through the wrapping device. Modules may include one bale or two or more bales such as 3, 4 or 5 bales. Modules of more than 5 bales may be wrapped such as in embodiments in which an assembled line of bales is wrapped with the only practical limit of the number of bales being wrapped in a module being the length of the wrapping material. The loading assembly 15, bed assembly 7 and discharge assembly 25 may also wrap a prearranged row of bales.

Compared to conventional systems for encasing articles in a protective wrap, the system described above has several advantages. The gathering mechanism bundles wrapping material after the wrapped articles have passed through the gathering mechanism which allows the wrapping material to be sealed. The gathering mechanism includes multiple separate gathering surfaces (five as shown) that converge towards a central compression area. Each separate gathering surface moves in some way generally towards the central compression area, in a way that the relative movement between the plastic wrap and the gathering surface is minimized. A gathering mechanism having multiple (e.g., five or more) separate surfaces, that each move in different ways, all converging towards the compression area, may successfully and reliably gather (e.g., without damage to the wrap by relative movement of the wrap and gathering surface) and compress the plastic wrap so that it can be secured. The gatherer mechanism is advantageous in wrapping round bales in which the protective wrap is moved a substantial length (e.g., about 24 inches or more) by each gathering surface from the tube to the compression area.

In embodiments in which the system includes two sealing devices, the end of a module may be sealed and the wrap material for wrapping additional articles may also be concurrently sealed. Use of cutter disposed between the two sealing devices allows the material to be severed between the two sealed portions of wrapping material. In this manner, sealing and severing of the material may be performed mechanically without direct operator contact of the wrap material. By minimizing the ratio of the width of the gathering mechanism relative to its opening (i.e., the width of materials wrapped) such as use of a ratio of 3:2 or less, the gathering mechanism may be used to wrap relatively large articles such as round bales while being characterized by a relatively small width which is beneficial for mobile operation (e.g., width restrictions on highways).

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1-23. (canceled)

24. A gathering mechanism for bunching wrapping material to seal the material after wrapping an article and having a vertical axis, the gathering mechanism comprising:
at least two portions that move to adjust the size of an opening formed between the portions from a wrapping position through which wrapped articles pass to a sealing position in which the wrapping material is bunched to seal the wrapping material, the gathering mechanism in the wrapping position having a widest width W₁ that extends between a first end and a second end of the gathering mechanism and that is perpendicular to the vertical axis, the opening in the wrapping positon having a width W₂ that is perpendicular to the vertical axis, and the ratio of W₁ to W₂ being less than about 3:2.

25. The gathering mechanism as set forth in claim 24 wherein W₂ is at least about 0.5 meters.

26. The gathering mechanism as set forth in claim 24 wherein the two portions are each arcuate and form a ring in the wrapping position.

27. The gathering mechanism as set forth in claim 26 wherein the first end and second end of the gathering mechanism are outermost portions of the ring in the wrapping position, the width W₂ of the opening being the distance between the first and second portion at the same vertical height at which W₁ is measured.

28. The gathering mechanism as set forth in claim 24 further comprising an actuator connected to the first portion and/or second portion to move the two portions from the wrapping position to the sealing position.

29. The gathering mechanism as set forth in claim 24 wherein the ratio of W₁ to W₂ is less than about 5:4.

30. A bale wrapping system for wrapping bales in a protective wrap, the system comprising:
a wrapping device for stretching a tube of wrapping material as a module of bales passes through the wrapping device and into the protective wrap; and
a gathering mechanism for bunching wrapping material to seal the material after wrapping the module of bales, the gathering mechanism comprising a set of arms that pivotally rotate to reduce the size of an opening to bunch the material within the opening and to a sealing position.

31. The bale wrapping system as set forth in claim 30 further comprising a sealing device that actuates to seal the wrapping material when the gathering mechanism is in the sealing position.

32. The bale wrapping system as set forth in claim 31 wherein the sealing device is a clipping device.

33. The bale wrapping system as set forth in claim 31 wherein the sealing device is a clipping device, the clipping device having a plunger and a die, the plunger being disposed within one arm of the gathering mechanism and the die being disposed within a second arm of the gathering mechanism.

34. The bale wrapping system as set forth in claim 31 wherein the sealing device is a first sealing device, the bale wrapping system further comprising:
a second sealing device for sealing an end of wrap material for wrapping a subsequent module; and
a cutter for severing the wrapping material, the cutter being disposed between the first and second sealing devices when the gathering mechanism is in the sealing position.

35. The bale wrapping system as set forth in claim 30 wherein the system is mobile and comprises:
a conveyor system for moving articles through the wrapping device and gathering mechanism;
a chassis that supports the wrapping device and gathering mechanism; and
ground-engaging wheels or tracks attached to the chassis.

36. A gathering and sealing system for wrapping articles in a protective wrap, the system comprising:
a gathering mechanism for bunching wrapping material to seal the material after wrapping the articles, the gathering mechanism comprising a set of arms that pivotally rotate to reduce the size of an opening to bunch the material within the opening and to a sealing position; and
a sealing device that actuates to seal the wrapping material when the gathering mechanism is in the sealing position, the sealing device being disposed within an arm of the gathering mechanism.

37. The gathering and sealing system as set forth in claim 36 wherein the sealing device is a clipping device.

38. The gathering and sealing system as set forth in claim 37, the clipping device having a plunger and a die, the plunger being disposed within one arm of the gathering mechanism and the die being disposed within a second arm of the gathering mechanism.

39. The gathering and sealing system as set forth in claim 36 wherein the sealing device is capable of rotating to a sealing position after wrapping the articles.

40. The gathering and sealing system as set forth in claim 36 wherein the arm in which the sealing device is disposed has two plates, the sealing device being disposed between the plates.

41. The gathering and sealing system as set forth in claim 36 wherein the gathering mechanism comprises:
two lower arms that are pivotally connected to a base; and
two upper arms, each upper arm being pivotally connected to a lower arm.

42. The gathering and sealing system as set forth in claim 41 comprising a scissor link that raises during rotation of the lower arms, the two upper arms and scissor link forming the opening through which the wrapping material is bunched in the sealed position.

43. The gathering and sealing system as set forth in claim 36 wherein the sealing device is a first sealing device, the gathering and sealing device further comprising:
a second sealing device for sealing a free end of wrap material for wrapping a subsequent article; and
a cutter being between disposed between the first and second sealing devices when the gathering mechanism is in the sealing position.
